(19) United States
(12) Patent Application Publication
(10) Pub. No.: US 2023/0033700 A1
(43) Pub. Date: Feb. 2, 2023

(54) LINEAR ARRAY OF IMAGE SENSOR CIRCUITS INCLUDING UNUSED PIXELS

(71) Applicant: HEWLETT-PACKARD DEVELOPMENT COMPANY, L.P., Spring, TX (US)

(72) Inventors: Gerardo OROZCO, San Diego, CA (US); Stuart ALLMAN, San Diego, CA (US); Dusty HENSON, San Diego, CA (US)

(73) Assignee: HEWLETT-PACKARD DEVELOPMENT COMPANY, L.P., Spring, TX (US)

(21) Appl. No.: 17/783,635

(22) PCT Filed: Dec. 10, 2019
(86) PCT No.: PCT/US2019/065503

§ 371 Date: Jun. 8, 2022

(51) Int. Cl. H04N 5/369; H04N 5/341

(52) U.S. Cl. CPC H04N 5/3692; H04N 5/3415

(57) ABSTRACT

Examples of the present disclosure relate to a linear array of image sensor circuits including unused pixels. An example apparatus includes a linear array of image sensor integrated circuits, each integrated circuit including a plurality of pixels, each pixel including a light-sensitive element, and an unused pixel at a start of the integrated circuit. The apparatus further includes a processor, and a non-transitory machine readable medium storing instructions executable by the processor to receive programming instructions specifying a number of unused pixels associated with each integrated circuit, measure image data pixel signals from the linear array of image sensor integrated circuits, including the unused pixels, and disregard image data associated with the unused pixels.

### BACKGROUND

Scanners use a light source to illuminate a section of an original item. A lens or an array of lenses redirects light reflected from or transmitted through the original item to project an image of a scan line onto a plurality of sensor chips arranged along the scan line. Each of the sensor chips includes light-sensitive elements that produce respective electrical signals related to the intensity of light falling on the element, which is in turn related to the reflectance, transmittance, or density of the corresponding portion of the original item. These electrical signals are read, and numerical values are assigned to the electrical signals. A scanning mechanism sweeps the scan line across the original item so that the light-sensitive elements read the successive scan lines. By associating the numerical values with their corresponding locations on the original item being scanned, a digital representation of the scanned item may be constructed.

### BRIEF DESCRIPTION OF THE DRAWINGS

FIG. 1 illustrates an example apparatus comprising a linear array of image sensor circuits including unused pixels, consistent with the present disclosure.

FIG. 2 illustrates an example waveform of a voltage output signal between adjacent integrated circuits, consistent with the present disclosure.

FIG. 3 illustrates an example computing device including non-transitory machine-readable medium storing executable instructions, consistent with the present disclosure.

FIG. 4 illustrates an example computing device including a non-transitory machine-readable medium storing executable instructions, consistent with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

An image scanning apparatus refers to or includes an apparatus for scanning an original image such as a document, a picture, a film, or the like, and converting the original image into digital data. The digital data may be displayed on a monitor of a computer or printed by a printer to be generated as an output image. Representative examples of an image scanning apparatus include a scanner, a copier, a facsimile, and a multifunction peripheral (MFP) that integrally implements these functions. The image scanning apparatus performs scanning by moving a document or by moving a scan module. As such, the scanning is performed under a condition in which, when the document or the scan module moves in a sub-scan direction, the actual scanning area for a unit pixel to be scanned is a unit pixel area at least twice as large as one pixel area in a main scan direction.

Linear Image Sensor refers to or includes a type of image sensor used to scan flat images or documents into electronic format for storage, display or transmission. A linear scanner module/assembly irradiates light generated by a light source onto the document or object to be scanned, reflects the light through the document or object, and uses a lens or a lens array to concentrate the reflected light on a sensor element. The light source is used to change the signal of the light into an electrical signal, thereby generating analog or digital pixel data.

A linear type scanner may include an image sensor scan assembly comprising a plurality of sensor chips arranged serially. Each sensor chip includes an array of light-sensitive elements, and each of the light-sensitive elements may be considered as a pixel, which may also refer to a corresponding area of an original object that is imaged onto that portion, or the digital value corresponding to a location in a digital image. During operation of the scanner, each imaging pixel in the array is read out in a serial fashion. When one sensor chip has finished reading imaging data from the pixels on the sensor chip, control of the video output is passed to the next sensor chip in the linear array. Each sensor chip in the linear array may have a slightly different direct current (DC) offset voltage at its video output, which may be seen as a sharp voltage bias change at the sensor boundaries. This sudden bias voltage change can cause the video signal to be temporarily disrupted on the first pixel of each sensor chip and may create dark streaks on an image that cannot be removed by calibration.

In accordance with examples of the present disclosure, the disruption between sensor chips and resultant image disruption, is accounted for by adding unused pixels to each sensor chip in the linear array. The addition of unused pixels, also referred to as dummy pixels, at the beginning of the sensor chip may allow additional time at the sensor to sensor transition to let the reset level clamp settle when there are differences between the DC offset between two adjacent chips.

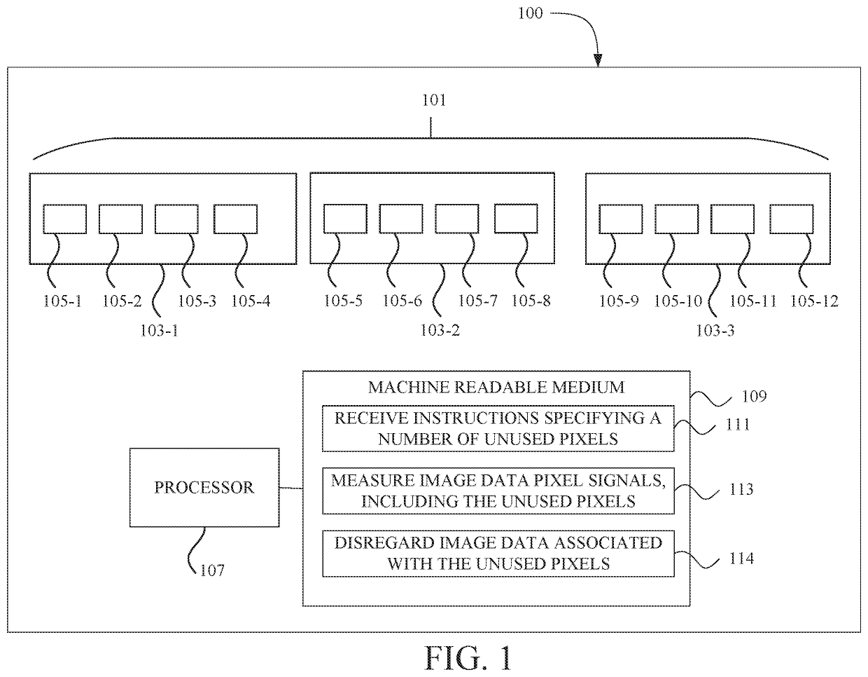

Turning now to the Figures, FIG. 1 illustrates an example apparatus 100 comprising a linear array of image sensor circuits including unused pixels, consistent with the present disclosure. Particularly, FIG. 1 illustrates an apparatus 100 comprising a linear array 101 of image sensor integrated circuits 103-1, 103-2, 103-3, collectively referred to herein as integrated circuits 103. Each integrated circuit (e.g., each of integrated circuits 103) include a plurality of pixels. For instance, integrated circuit 103-1 includes pixels 105-1, 105-2, 105-3, and 105-4. Similarly, integrated circuit 103-2 includes pixels 105-5, 105-6, 105-7, and 105-8. Moreover, integrated circuit 103-3 includes pixels 105-9, 105-10, 105-11, and 105-12. The integrated circuits 103 may also be referred to as sensor chips. The pixels of the integrated circuits 103 are referred to collectively as pixels 105, and each of the pixels 105 include a light-sensitive element, which may also refer to a corresponding area of an original object that is imaged onto that portion, or the digital value corresponding to a location in a digital image.

In various examples of the present disclosure, each of the integrated circuits 103 may also include unused pixels at a start of the integrated circuit. Each unused pixel may also be referred to as a dummy pixel. An unused pixel refers to or includes a pixel that exists in programming but is not physically present in the integrated circuit. For instance, integrated circuit 103-1 may include an unused pixel prior to pixel 105-1, and integrated circuit 103-2 may include an unused pixel prior to pixel 105-5, but neither integrated circuit 103-1 nor integrated circuit 103-2 include a physical pixel in such locations.

The number of unused pixels associated with each of the integrated circuits 103 may be customized and/or programmed, such that a number of unused pixels (e.g., dummy pixels) could be assigned for each integrated circuit. The unused pixels effectively provide additional time at the sensor chip to sensor chip transition to allow the reset level clamp of the apparatus 100 to settle when there are differences between the DC offset between two adjacent sensor chips. The amount of additional time provided at the sensor chip to sensor chip transition may be adjusted based on the scan rate of the apparatus. That is, the faster the transition between integrated circuit 103-1 and integrated circuit 103-2, the greater the number of unused pixels that may be used in the transition between integrated circuit 103-1 and integrated circuit 103-2. Similarly, the slower the transition between integrated circuit 103-1 and integrated circuit 103-2, the fewer number of unused pixels that may be used in the transition between integrated circuit 103-1 and integrated circuit 103-2.

By programming the number of unused pixels per integrated circuit, the rate of transition between each of the integrated circuits 103 may be configured. This programmability also provides the flexibility to use the sensor with Digital Application-Specific Integrated Circuits (DASICs) that either have the function to remove in-between unused pixels, or to use it with DASIC's that don't have the function to remove in-between unused pixels.

To facilitate the programmability of the integrated circuits 103 and implementation of unused pixels 105, the apparatus 100 includes a processor 107 in various examples. The processor 107 may control each constituent element of the apparatus 100. The processor 107 may be embodied with a central processing unit (CPU), an application specific integrated circuit (ASIC), a system on chip (SoC), or the like and detect whether a scan command is received from a user. The scan command may be input through an operation input unit provided in the apparatus 100, or input through a communicator as a signal from an external device.

The processor 107 may be communicatively coupled to a machine-readable storage medium 109 storing instructions executable by the processor 107 to perform a number of functions. For instance, the machine readable medium 109 may include instructions 111 executable by the processor 107 to receive programming instructions specifying a number of unused pixels associated with each integrated circuit. The apparatus 100 may be programmed to include a specific number of unused pixels, and/or a scan rate of the apparatus 100 may determine the number of unused pixels. Similarly, the machine readable medium 109 may include instructions 113 executable by the processor 107 to measure image data pixel signals from the linear array 101 of image sensor integrated circuits 103, including the unused pixels, and instructions 114 executable by the processor 107 to disregard image data associated with the unused pixels.

In some examples, the machine readable medium 109 includes instructions executable by the processor 107 to receive input specifying a scan rate for the linear array 101 of image sensor integrated circuits 103. The scan rate may be provided by a user and/or an additional computing device communicatively coupled to the apparatus 100. Similarly, the machine readable medium 109 may include instructions executable by the processor to select a number of unused pixels for each integrated circuit based on the scan rate. For instance, based on the scan rate to be implemented by the integrated circuits 103, a number of unused pixels may be selected for each integrated circuit.

The processor 107 may communicate with the integrated circuits to control the number of unused pixels selected. In some examples, the number of unused pixels may be controlled by input pad lines. For instance, each of the integrated circuits may include a first input pad line and a second input pad line (not illustrated in FIG. 1). The machine readable medium 109 may include instructions executable by the processor 107 to, for each integrated circuit, specify the number of unused pixels for the integrated circuit by driving the first input pad line and the second input pad line high or low. That is, integrated circuit 103-1 includes a first input pad line and a second input pad line, integrated circuit 103-2 includes a first input pad line and a second input pad line, and integrated circuit 103-3 includes a first input pad line and a second input pad line. The input pad line for each of the integrated circuits may be driven high or low to select a specified number of unused pixels. As an example, to select zero unused pixels for each of the integrated circuits 103, both the first input line and the second input line for each integrated circuit may be driven low. To select one unused pixel for each of the integrated circuits 103, the first input line for each integrated circuit may be driven low, whereas the second input line for each integrated circuit may be driven high. To select two unused pixels for each of the integrated circuits 103, the first input line for each integrated circuit may be driven high, whereas the second input line for each integrated circuit may be driven low. To select four unused pixels for each both the first input line and the second input line for each integrated circuit may be driven high. Accordingly, the machine readable medium 109 may include instructions executable by the processor 107 to, for each integrated circuit, drive the first input pad line high or low and the second input pad line high or low (as illustrated in Table 1 below), based on a scan rate of the linear array 101 of image sensor integrated circuits 103.

TABLE 1

| Input line 1 | Input line 2 | # of unused pixels |
|---|---|---|
| Low | Low | 0 |
| Low | High | 1 |
| High | Low | 2 |
| High | High | 4 |

Additionally, and/or alternatively, the number of unused pixels may be specified by a resolution select input line. For instance, each of the integrated circuits 103 may include a resolution select input line (not illustrated in FIG. 1). The machine readable medium 109 may include instructions executable by the processor 107 to, for each integrated circuit, send a select number of pulses to the integrated circuit corresponding with a select number of unused pixels. The integrated circuits 103 use a train of pulses to program the scanning resolution on a resolution-select input line. This train of pulses may also program the number of unused pixels for each integrated circuit. For instance, sending 1 pulse selects 200 pixels per inch (ppi) and zero unused pixels, 2 pulses selects 300 ppi and zero unused pixels, and 3 pulses selects 600 ppi and zero unused pixels. Additional programming values are included in Table 2 below:

TABLE 2

| Number | Resolution | # of unused |
|---|---|---|
| of Pulses | Selection (ppi) | pixels |
| 1 | 200 | 0 |
| 2 | 300 | 0 |
| 3 | 600 | 0 |
| 4 | 200 | 1 |
| 5 | 300 | 1 |
| 6 | 600 | 1 |
| 7 | 200 | 2 |
| 8 | 300 | 2 |
| 9 | 600 | 2 |

To ensure that the scanned image looks continuous, the image data associated with each of the unused pixels may be ignored and/or discarded. As such, the machine readable medium 109 may include instructions executable by the processor 107 to, for each integrated circuit, disregard image data associated with the unused pixels.

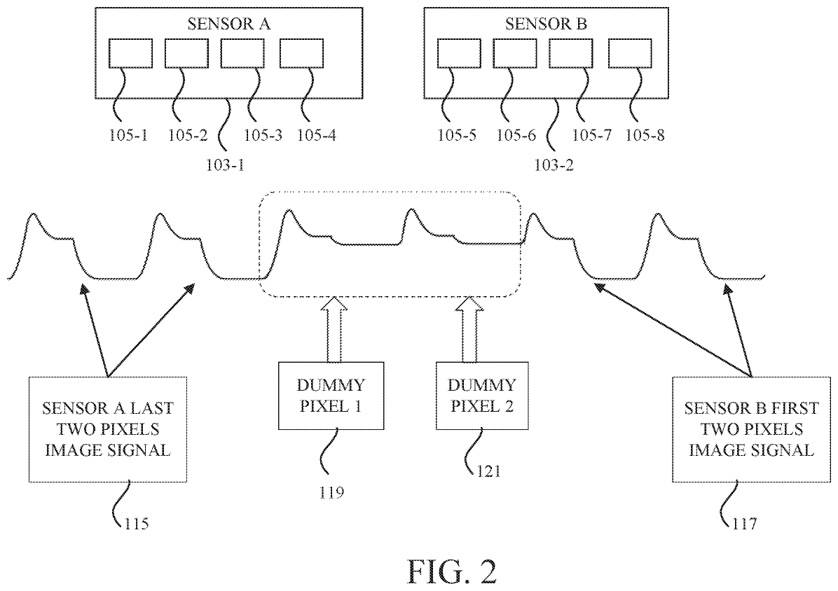

FIG. 2 illustrates an example waveform of a voltage output signal between adjacent integrated circuits, consistent with the present disclosure. Particularly, FIG. 2 illustrates a portion of the apparatus 100 illustrated in FIG. 1. As illustrated in FIG. 2, a first integrated circuit 103-1 (e.g., sensor A) is disposed adjacent to a second integrated circuit 103-2 (e.g., sensor B). As discussed with regards to FIG. 1, each of the first integrated circuit 103-1 (e.g., sensor A) and the second integrated circuit 103-2 (e.g., sensor B) may include a plurality of pixels (e.g., pixels 105). Additionally, the first integrated circuit 103-1 (e.g., sensor A) and the second integrated circuit 103-2 (e.g., sensor B) may each have a single unused pixel, or dummy pixel.

The waveform illustrated in FIG. 2 includes the pixel image signals from the last two pixels of sensor A at 115. These pixel image signals correspond with pixels 105-3 and 105-4. Similarly, the waveform illustrated in FIG. 2 includes the pixel image signals from the first two pixels of sensor B at 117. These pixel image signals correspond with pixels 105-5 and 105-6. In the example illustrated in FIG. 2, each of sensor A (e.g., integrated circuit 103-1) and sensor B (e.g., integrated circuit 103-2) include two unused pixels, or “dummy pixels,” the voltage output signal for the first dummy pixel 119 and the voltage output signal for the second dummy pixel 121 normalize while the reset level clamp settles between sensor A and sensor B. While FIG. 2 illustrates two integrated circuits and the associated voltage output signal, examples are not so limited. The apparatus 100 may include hundreds of integrated circuits, each including a specified number of unused pixels.

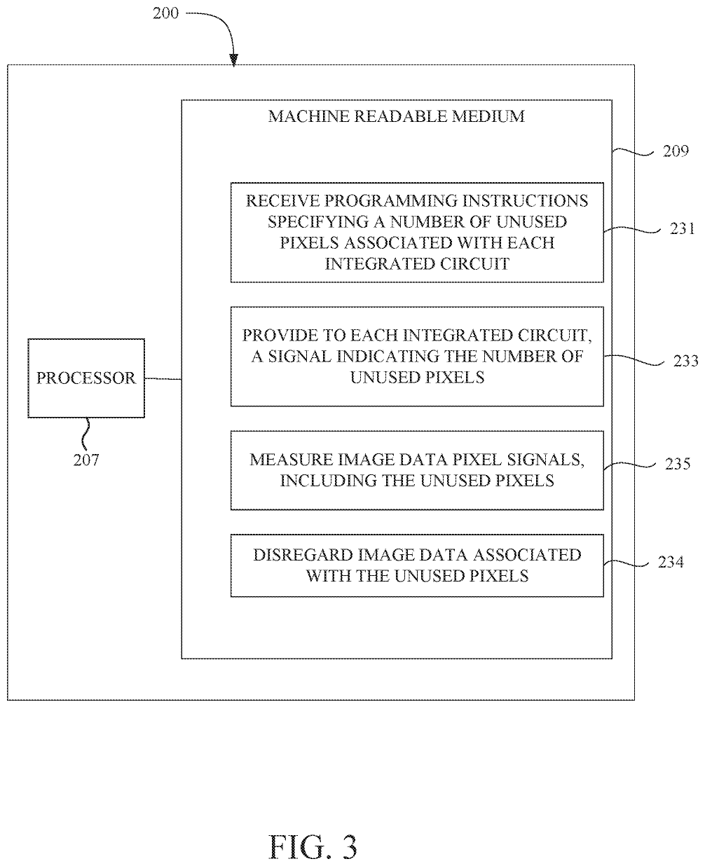

FIG. 3 illustrates an example computing device 200 including a non-transitory machine-readable medium storing executable instructions, consistent with the present disclosure. The computing device 200, in accordance with examples herein, includes a scanning apparatus such as apparatus 100 illustrated by FIG. 1.

The computing device 200 includes a processor 207 and a machine readable medium 209 storing a set of instructions 231, 233, 235, and 234. The machine readable medium 209 may, for example, include read-only memory (ROM), random-access memory (RAM), electrically erasable programmable read-only memory (EEPROM), Flash memory, a solid-state drive, and/or discrete data register sets.

In various examples, the non-transitory machine-readable storage medium 209 stores instructions 231 executable by a processor 207 that, when executed by the processor, cause the processor to receive programming instructions specifying a number of unused pixels associated with each integrated circuit in a linear array of image sensor integrated circuits.

Also, the non-transitory machine-readable storage medium 209 stores instructions 233 executable by the processor 207 that, when executed by the processor, cause the processor to provide to each integrated circuit, a signal indicating the number of unused pixels. Moreover, instructions 235, when executed by the processor 207, cause the processor to measure image data pixel signals from the linear array of image sensor integrated circuits, including the unused pixels, and instructions 234, when executed by the processor 207, cause the processor to disregard image data associated with the unused pixels.

In various specific examples, the processor 207 may carry out additional or more specific operations stored on the machine readable medium 209. For instance, as discussed with regards to FIG. 1 and FIG. 2, the number of unused pixels may be configurable. Accordingly, the instructions 233 to provide to each integrated circuit, a signal indicating the number of unused pixels may include instructions that, when executed by the processor 207, cause the processor to send a number of pulses to each integrated circuit specifying a resolution and a number of unused pixels associated with each respective integrated circuit. Examples of such pulses and corresponding unused pixels are provided in Table 2, above.

Additionally and/or alternatively, the machine readable medium 209 may include instructions that, when executed by the processor 207, cause the processor 207 to receive input specifying a scan rate for the linear array of image sensor integrated circuits, and select the number of unused pixels associated with each integrated circuit responsive to and based on the received scan rate.

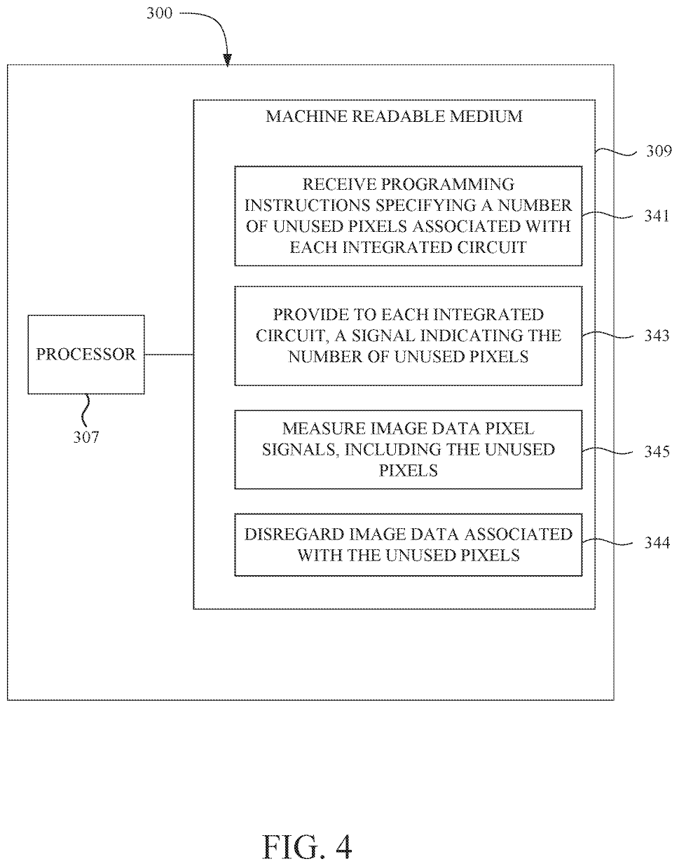

FIG. 4 illustrates an example computing device 300 including a non-transitory machine-readable medium storing executable instructions, consistent with the present disclosure. The computing device 300, in accordance with examples herein, includes a scanning apparatus such as apparatus 100 illustrated by FIG. 1.

In the example illustrated in FIG. 4, the computing device 300 includes a processor 307 and a machine readable medium 309 storing a set of instructions 341, 343, 345, and 344. The machine readable medium 309 may, for example, include ROM, RAM, EEPROM, Flash memory, a solid-state drive, and/or discrete data register sets.

The non-transitory machine-readable storage medium 309 may store instructions 341 executable by a processor 307 that, when executed by the processor 307, cause the processor 307 to receive instructions specifying a scan rate associated with a linear array of image sensor integrated circuits. In various examples, a number of unused pixels may be determined from the scan rate. Therefore, the number of unused, or “dummy” pixels, may be determined from the scan rate utilized by the apparatus. The instructions 343, when executed by the processor 307, cause the processor 307 to provide to each integrated circuit in the linear array, a signal indicating a number of unused pixels associated with the corresponding integrated circuit, based on the scan rate of the linear array. The signal indicating the number of unused pixels may be provided by pulse train, and/or by input pad lines, as discussed herein.

The instructions 345, when executed by the processor 307, cause the processor 307 to measure image data pixel signals from the integrated circuits, including the unused pixels, and the instructions 344, when executed by the processor 207, cause the processor to disregard image data associated with the unused pixels. Particularly, image data signals may be obtained from the pixels in the linear array, whereas image data associated received while the apparatus is allegedly reading image data from the unused pixels is discarded, as the unused pixels do not physically exist and therefore do not obtain image data.

As discussed herein, the number of unused pixels may be configurable. As such, the instructions 343 to provide to each integrated circuit, a signal indicating the number of unused pixels may include instructions that, when executed by the processor 307, cause the processor 307 to, responsive to a determination that the scan rate is below a threshold scan rate, provide to each integrated circuit, a signal specifying that no unused pixels are associated with the corresponding integrated circuit. Various scan rate thresholds may be defined, indicating a scan rate at which additional time between integrated circuits would be beneficial to improve image quality. As illustrated in Table 1 above, a signal indicating that no unused pixels are to be selected, may be provided by driving a first input pad line of the corresponding integrated circuit and a second input pad line of the corresponding integrated circuit low.

As a further illustration, the instructions 343 to provide to each integrated circuit, a signal indicating the number of unused pixels may include instructions that, when executed by the processor 307, cause the processor 307 to, responsive to a determination that the scan rate is above a threshold scan rate, provide to each integrated circuit, a signal specifying that one unused pixel is associated with the corresponding integrated circuit. As illustrated in Table 1 above, a signal indicating that one unused pixel is to be selected, may be provided by driving a first input pad line of the corresponding integrated circuit low and a second input pad line of the corresponding integrated circuit high.

Yet further, the instructions 343 to provide to each integrated circuit, a signal indicating the number of unused pixels may include instructions that, when executed by the processor 307, cause the processor 307 to, responsive to a determination that the scan rate is above a second threshold scan rate, provide to each integrated circuit, a signal specifying that two unused pixels are associated with the corresponding integrated circuit. As illustrated in Table 1 above, a signal indicating that two unused pixels are to be selected, may be provided by driving a first input pad line of the corresponding integrated circuit high and a second input pad line of the corresponding integrated circuit low.

Moreover, the instructions 343 to provide to each integrated circuit, a signal indicating the number of unused pixels may include instructions that, when executed by the processor 307, cause the processor 307 to, responsive to a determination that the scan rate is above a third threshold scan rate, provide to each integrated circuit, a signal specifying that four unused pixels are associated with the corresponding integrated circuit. As illustrated in Table 1 above, a signal indicating that two unused pixels are to be selected, may be provided by driving a first input pad line of the corresponding integrated circuit high and a second input pad line of the corresponding integrated circuit high.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited by the claims and the equivalents thereof.

1. An apparatus, comprising:
a linear array of image sensor integrated circuits, each integrated circuit including:
a plurality of pixels, each pixel including a light-sensitive element; and
an unused pixel at a start of the integrated circuit;
a processor; and
a non-transitory machine readable medium storing instructions executable by the processor to:
receive programming instructions specifying a number of unused pixels associated with each integrated circuit;
measure image data pixel signals from the linear array of image sensor integrated circuits, including the unused pixels; and
disregard image data associated with the unused pixels.

2. The apparatus of claim 1, wherein the machine-readable medium includes instructions executable by the processor to receive input specifying a scan rate for the linear array of image sensor integrated circuits.

3. The apparatus of claim 2, wherein the machine-readable medium includes instructions executable by the processor to select a number of unused pixels for each integrated circuit based on the scan rate.

4. The apparatus of claim 1, wherein each integrated circuit includes a first input pad line and a second input pad line, and wherein the machine-readable medium includes instructions executable by the processor to, for each integrated circuit:
specify the number of unused pixels for the integrated circuit by driving the first input pad line and the second input pad line high or low.

5. The apparatus of claim 1, wherein each integrated circuit includes a first input pad line and a second input pad line, and wherein the machine-readable medium includes instructions executable by the processor to, for each integrated circuit:
drive the first input pad line high or low and the second input pad line high or low, based on a scan rate of the linear array of image sensor integrated circuits.

6. The apparatus of claim 1, wherein each integrated circuit includes a resolution select input line, and wherein the machine-readable medium includes instructions executable by the processor to, for each integrated circuit:
send a select number of pulses to the integrated circuit corresponding with a select number of unused pixels.

7. The apparatus of claim 1, wherein each integrated circuit includes a resolution select input line, and wherein the machine-readable medium includes instructions executable by the processor to, for each integrated circuit:
send a number of pulses to each integrated circuit specifying a resolution and a number of unused pixels associated with each respective integrated circuit.

8. A non-transitory machine-readable storage medium storing instructions executable by a processor that, when executed by the processor, cause the processor to:
receive programming instructions specifying a number of unused pixels associated with each integrated circuit in a linear array of image sensor integrated circuits;
provide to each integrated circuit, a signal indicating the number of unused pixels;
measure image data pixel signals from the linear array of image sensor integrated circuits, including the unused pixels; and
disregard image data associated with the unused pixels.

9. The medium of claim 8, wherein the instructions to provide to each integrated circuit, a signal indicating the number of unused pixels includes instructions that, when executed by the processor, cause the processor to:
send a number of pulses to each integrated circuit specifying a resolution and a number of unused pixels associated with each respective integrated circuit.

10. The medium of claim 8, further including instructions that, when executed by the processor, cause the processor to:
receive input specifying a scan rate for the linear array of image sensor integrated circuits; and
select the number of unused pixels associated with each integrated circuit responsive to and based on the received scan rate.

11. A non-transitory machine-readable storage medium storing instructions executable by a processor that, when executed by the processor, cause the processor to:
receive instructions specifying a scan rate associated with a linear array of image sensor integrated circuits;
provide to each integrated circuit in the linear array, a signal indicating a number of unused pixels associated with the corresponding integrated circuit, based on the scan rate of the linear array;
measure image data pixel signals from the integrated circuits, including the unused pixels; and
disregard image data associated with the unused pixels.

12. The medium of claim 11, wherein the instructions to provide to each integrated circuit, a signal indicating the number of unused pixels include instructions that, when executed by the processor, cause the processor to:
responsive to a determination that the scan rate is below a threshold scan rate, provide to each integrated circuit, a signal specifying that no unused pixels are associated with the corresponding integrated circuit, by driving a first input pad line of the corresponding integrated circuit and a second input pad line of the corresponding integrated circuit low.

13. The medium of claim 11, wherein the instructions to provide to each integrated circuit, a signal indicating the number of unused pixels include instructions that, when executed by the processor, cause the processor to:
responsive to a determination that the scan rate is above a threshold scan rate, provide to each integrated circuit, a signal specifying that one unused pixel is associated with the corresponding integrated circuit, by driving a first input pad line of the corresponding integrated circuit low and a second input pad line of the corresponding integrated circuit high.

14. The medium of claim 11, wherein the instructions to provide to each integrated circuit, a signal indicating the number of unused pixels include instructions that, when executed by the processor, cause the processor to:
responsive to a determination that the scan rate is above a second threshold scan rate, provide to each integrated circuit, a signal specifying that two unused pixels are associated with the corresponding integrated circuit, by driving a first input pad line of the corresponding integrated circuit high and a second input pad line of the corresponding integrated circuit low.

15. The medium of claim 11, wherein the instructions to provide to each integrated circuit, a signal indicating the number of unused pixels include instructions that, when executed by the processor, cause the processor to:
responsive to a determination that the scan rate is above a third threshold scan rate, provide to each integrated circuit, a signal specifying that four unused pixels are associated with the corresponding integrated circuit, by driving a first input pad line of the corresponding integrated circuit high and a second input pad line of the corresponding integrated circuit high.
